(19) United States
(12) Patent Application Publication
(10) Pub. No.: US 2022/0229552 A1
(43) Pub. Date: Jul. 21, 2022

(54) COMPUTER SYSTEM INCLUDING MAIN MEMORY DEVICE HAVING HETEROGENEOUS MEMORIES, AND DATA MANAGEMENT METHOD THEREOF

(71) Applicant: SK hynix Inc., Gyeonggi-do (KR)

(72) Inventors: Mi Seon HAN, Gyeonggi-do (KR); Hyung Jin LIM, Gyeonggi-do (KR); Jong Ryool KIM, Gyeonggi-do (KR); Myeong Joon KANG, Gyeonggi-do (KR)

(21) Appl. No.: 17/150,183

(22) Filed: Jan. 15, 2021

(51) Int. Cl. G06F 3/06

(52) U.S. Cl. CPC G06F 3/0604; G06F 3/0673; G06F 3/0655

(57) ABSTRACT

A computer system includes a first main memory, a second main memory having an access latency different from that of the first main memory and, a memory management system configured to manage the second main memory by dividing it into a plurality of pages, detect a hot page, among the plurality of pages, based on a write count of data stored in the second main memory, and move data of the hot page to a new page in the second main memory and to the first main memory.

### BACKGROUND

### 1. Technical Field

Various embodiments generally relate to a computer system, and more particularly, to a computer system including a memory device having heterogeneous memories and a data management method thereof.

### 2. Related Art

A computer system may include various types of memory devices. A memory device includes a memory for storing data and a memory controller which controls the operation of the memory. A memory may be a volatile memory such as a dynamic random access memory (DRAM) or a static random access memory (SRAM), or a nonvolatile memory such as an electrically erasable programmable ROM (EEPROM), a ferroelectric RAM (FRAM), a phase change RAM (PCRAM), a magnetic RAM (MRAM) or a flash memory. Data stored in a volatile memory is lost when power supply is interrupted, whereas data stored in a nonvolatile memory is not lost even when power supply is interrupted. Recently, a main memory device in which heterogeneous memories are mounted is being developed.

A volatile memory has a characteristic that an operation (e.g., write and read) speed is high but energy consumption is large, and a nonvolatile memory has a characteristic that energy efficiency is excellent but the lifetime thereof is limited. Due to this fact, in order to improve the performance of a memory system, data that is frequently accessed, e.g., hot data, and data that is less frequently accessed, e.g., cold data, need to be separately stored depending on the characteristic of a memory.

### SUMMARY

In an embodiment, a computer system may include: a first main memory, a second main memory having an access latency different from that of the first main memory and, a memory management system configured to manage the second main memory by dividing it into a plurality of pages, detect a hot page, among the plurality of pages, based on a write count of data stored in the second main memory, and move data of the hot page to a new page in the second main memory and to the first main memory.

In an embodiment, a data management method of a computer system including a first main memory and a second main memory which has an access latency different from that of the first main memory may include: detecting, by a memory management system, a hot page based on a write count of data stored in the second main memory, the memory management system managing the second main memory by dividing it into a plurality of pages; and moving, by the memory management system, data of the hot page to a new page in the second main memory and to the first main memory.

In an embodiment, a computer system may include: a central processing unit; a main memory device including a first main memory and a second main memory which are heterogeneous memories, the second main memory including a plurality of pages; and a memory management system coupled between the central processing unit and a main memory device, including a first memory controller configured to control the first main memory and a second memory controller configured to control the second main memory. The memory management system being configured to control the first and second memory controllers to: receive data from the central processing unit in response to a write command; determine whether the received data is hot data; when it is determined that the received data is hot data, determine a margin of the first main memory; and when it is determined that the received data is hot data and that the margin of the first main memory is greater than a threshold margin, move the hot data from its current location in the second main memory to another location in the second main memory, and store the hot data in the first main memory with a tag indicating that it is not to be evicted from the first main memory.

### BRIEF DESCRIPTION OF THE DRAWINGS

FIG. 1 is a diagram illustrating a configuration of a computer system in accordance with an embodiment.

FIG. 2 is a diagram illustrating a configuration of a memory management system in accordance with an embodiment.

FIGS. 3 and 4 are flow charts illustrating a data management method of a computer system in accordance with an embodiment.

FIGS. 5 and 6 are diagrams illustrating examples of systems in accordance with embodiments of the present invention.

### DETAILED DESCRIPTION

A computer system including main memory device having heterogeneous memories, and a data management method thereof is described below with reference to the accompanying drawings through various embodiments. Throughout the specification, reference to “an embodiment,” “another embodiment” or the like is not necessarily to only one embodiment, and different references to any such phrase are not necessarily to the same embodiment(s). The term “embodiments” when used herein does not necessarily refer to all embodiments.

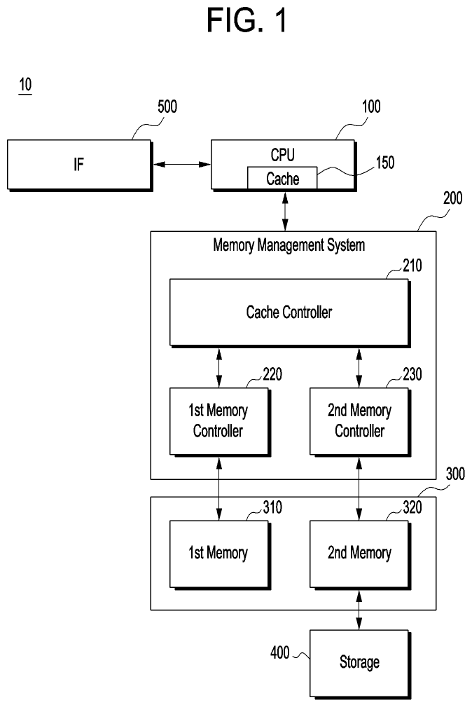

FIG. 1 is a diagram illustrating a configuration of a computer system 10 in accordance with an embodiment.

Referring to FIG. 1, the computer system 10 may include a central processing unit (CPU) 100, a memory management system 200, a main memory device 300, a storage 400 and an external device interface (IF) 500 which are electrically coupled through a system bus. The CPU 100 may include a cache memory 150. Alternatively, the cache memory 150 may be provided external, and operably coupled, to the CPU 100.

The CPU 100 may be any of various commercially available processors. A dual microprocessor, a multi-core processor and other multi-processor architectures may be adopted as the CPU 100.

The CPU 100 may process or execute programs and/or data stored in the main memory device 300. For example, the CPU 100 may process or execute the programs and/or the data in response to a clock signal outputted from a clock signal generator (not illustrated). The CPU 100 may access the cache memory 150 and the main memory device 300 through the memory management system 200.

The cache memory 150 refers to a general-purpose memory for reducing a bottleneck phenomenon due to a significant difference in speeds between two devices in communication. That is to say, the cache memory 150 serves to alleviate a data bottleneck phenomenon between the CPU 100 which operates at a high speed and the main memory device 300 which operates at a relatively low speed. The cache memory 150 may cache data which is frequently accessed by the CPU 100 among data stored in the main memory device 300.

Although not illustrated, the cache memory 150 may be configured at a plurality of levels depending on an operating speed and a physical distance to the CPU 100. For example, the cache memory 150 may include a first level (L1) cache and a second level (L2) cache. In general, the L1 cache may be built in the CPU 100 and may be used first for reference to and use of data. The L1 cache may be fastest in speed among caches, but may be small in storage capacity. If data does not exist in the L1 cache (for example, in the case of a cache miss), the CPU 100 may access the L2 cache. The L2 cache may be slower in speed but larger in storage capacity than the L1 cache. If data does not exist even in the L2 cache, the CPU 100 accesses the main memory device 300.

The main memory device 300 may include a first main memory 310 and a second main memory 320. The first main memory 310 and the second main memory 320 may be heterogeneous memories whose structures and access latencies are different. For example, the first main memory 310 may include a volatile memory (VM), and the second main memory 320 may include a nonvolatile memory (NVM). For instance, the volatile memory may be a dynamic random access memory (DRAM) and the nonvolatile memory may be a phase change RAM (PCRAM), but the disclosure is not specifically limited thereto.

In an embodiment, the first main memory 310 may be a last level cache (LLC) of the CPU 100. In another embodiment, the first main memory 310 may be a write buffer for the second main memory 320.

The memory management system 200 may store programs and/or data, used or processed in the CPU 100, in the cache memory 150 and/or the main memory device 300 under the control of the CPU 100. Further, the memory management system 200 may read data, stored in the cache memory 150 and/or the main memory device 300, under the control of the CPU 100.

The memory management system 200 may include a cache controller 210, a first memory controller 220 and a second memory controller 230.

The cache controller 210 controls general operation of the cache memory 150. That is to say, the cache controller 210 includes an internal algorithm and hardware for processing the internal algorithm, which may include determining which data among data loaded in the main memory device 300 is to be stored in the cache memory 150, and which data is to be replaced when the cache memory 150 is full and whether data requested from the CPU 100 exists in the cache memory 150. To this end, the cache controller 210 may use a mapping table which represents a relationship between cached data and data stored in the main memory device 300.

The first memory controller 220 may divide the first main memory 310 into a plurality of blocks, and may control the operation of the first main memory 310. In an embodiment, the first memory controller 220 may control the first main memory 310 to perform an operation corresponding to a command received from the CPU 100. The first main memory 310 may perform an operation of writing data to a memory cell array (not illustrated) or reading data from the memory cell array, depending on a command provided from the first memory controller 220.

The second memory controller 230 may control the operation of the second main memory 320. The second memory controller 230 may control the second main memory 320 to perform an operation corresponding to a command received from the CPU 100. In an embodiment, the second memory controller 230 may manage the data storage region of the second main memory 320 by the unit of a page.

In particular, when a hot page, that is, a page in which hot data is stored, is detected among pages of the second main memory 320, the memory management system 200 may move the detected hot data to another page in the second main memory 320, thereby uniformly managing the wear of the second main memory 320.

In the following description, a hot page and hot data may have the same meaning. Hot page or hot data may be a page or data whose write count or re-write count has reached a set threshold value TH.

In addition, by allowing detected hot data to remain in the first main memory 310, that is, by preventing detected hot data from being evicted from the first main memory 310 to the second main memory 320, quick access to hot data may be provided, and at the same time, the number of accesses to the second main memory 320 may be minimized.

Through this, according to the present technology, wear-leveling and wear-reduction of the second main memory 320 may be simultaneously achieved.

The computer system 10 may store data in the main memory device 300 for a short time and temporarily. The main memory device 300 may store data having a file system format, or may store an operation system program by separately setting a read-only space. When the CPU 100 executes an application program, at least part of the application program may be read from the storage 400 and be loaded in the main memory device 300.

The storage 400 may include at least one of a hard disk drive (HDD) and a solid state drive (SSD). The storage 400 may serve as a storage medium in which the computer system 10 stores user data for a long time. An operating system (OS), an application program, program data and so forth may be stored in the storage 400.

The external device interface 500 may include an input device interface, an output device interface, and a network device interface. An input device may be a keyboard, a mouse, a microphone or a scanner. A user may input a command, data and information to the computer system 10 through the input device.

An output device may be a monitor, a printer or a speaker. An execution process and a processing result of the computer system 10 for a user command may be expressed through the output device.

A network device may include hardware and software which are configured to support various communication protocols. The computer system 10 may communicate with another computer system which is remotely located, through the network device interface.

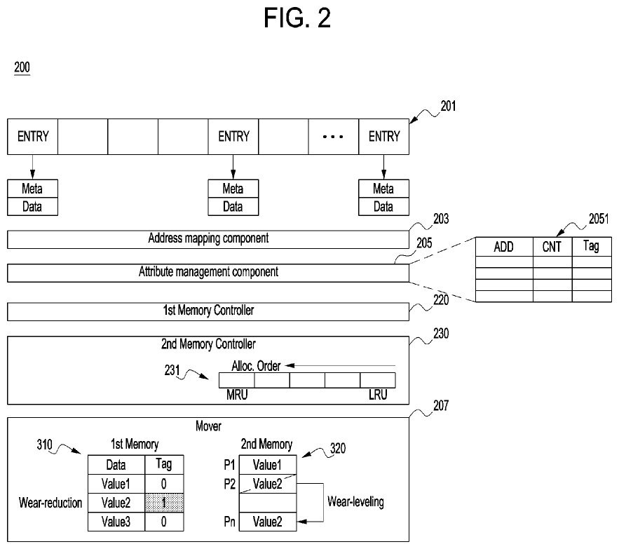

FIG. 2 is a diagram illustrating a configuration of a memory management system 200 in accordance with an embodiment.

Referring to FIG. 2, the memory management system 200 may include an entry management component 201, an address mapping component 203, an attribute management component 205, the first memory controller 220, the second memory controller 230, and a mover 207.

The entry management component 201 may manage data, used in the computer system 10, by the unit of an entry (ENTRY). Each entry may include a data value and meta-information (META) including an identifier of the data value. In an embodiment, the entry management component 201 may manage data to be transmitted to and received from a host device or a client device coupled to the computer system 10, by configuring the data with a key-value entry which uses a key as a unique identifier.

Data requested by the host device or client device may be cached in the cache memory 150. If so, the write-requested data is moved to the main memory device 300 through a write-through or a write-back depending on a cache management policy adopted in the computer system 10.

The address mapping component 203 maps a logical address of read-requested or write-requested data to a physical address used in the computer system 10. In an embodiment, the address mapping component 203 may map an address of the cache memory 150 or an address of the main memory device 300 in correspondence to a logical address, and may manage the validity of data stored in a corresponding region.

Through this process, the memory management system 200 may access the cache memory 150 or the main memory device 300 in order to process write-requested or read-requested data.

The attribute management component 205 may manage whether the attribute of write-requested data is, for example, hot data or cold data, based on a write count of the write-requested data.

In an embodiment, the attribute management component 205 may manage a logical address ADD and a write count CNT of write-requested data, in an access count table 2051. In particular, the attribute management component 205 may manage a write count of each logical address of data stored in the second main memory 320 among write-requested data, in the access count table 2051.

The attribute management component 205 may determine, as hot data, data whose write count CNT is greater than or equal to the set threshold value TH, among data stored in the second main memory 320.

The first memory controller 220 may divide the first main memory 310 into a plurality of blocks, and may manage a usage state thereof. The first memory controller 220 may determine a margin of the first main memory 310 based on a cache miss count for the first main memory 310 and the number of the blocks included in the first main memory 310. If a cache miss count for the first main memory 310 during a set time is greater than the number of the blocks of the first main memory 310, that is, if data previously stored in the first main memory 310 is not accessed during the set time, the first memory controller 220 may determine that a margin of the first main memory 310 is high. In an embodiment, the margin may be a criterion for determining whether data previously stored in the first main memory 310 may be overwritten.

Here, “block” should be understood to mean a data storage unit of the first main memory 310.

The second memory controller 230 may select a specific page of the second main memory 320, in response to detection of hot data, using the attribute management component 205.

The second memory controller 230 may divide the second main memory 320 into a plurality of pages, and may manage the pages in a least recently used (LRU) queue 231 in which addresses of the respective pages are stored in a particular access order, e.g., from LRU to MRU or vice versa. In order to prevent the second main memory 320 from wearing as hot data detected by the attribute management component 205 is continuously updated at a fixed position in the second main memory 320, the second memory controller 230 may select from the LRU queue 231 a new page to which the hot data is to be moved.

Here, “page” should be understood to mean a data storage unit of the second main memory 320. Block and page may have the same or different sizes.

The mover 207 may move the hot data to the new page selected by the second memory controller 230.

Referring to FIG. 2, among data stored in the second main memory 320, data Value2 stored in a second page P2 may be detected as hot data. If Value2 is repeatedly updated in the second page P2, the lifespan of the corresponding region may be degraded or shortened. Therefore, if Value2 is detected as hot data by the attribute management component 205, the second memory controller 230 allocates a new page Pn to which Value2 is to be moved, so that Value2 is moved to the new page Pn. Thereafter, the second memory controller 230 invalidates the data of the second page P2 in which Value2 was stored.

The mover 207 may store Value2 in the first main memory 310. Value2 may be managed through the access count table 2051, by adding a hot data tag (Tag) indicating that Value2 is hot data whose page has been replaced in the second main memory 320.

If the first main memory 310 is full, a data eviction operation of evicting data of the first main memory 310 to the second main memory 320 is performed. Thereafter, it is determined that data added with the hot data tag has a low priority of eviction to the second main memory 320, and thereby, an access count to the second main memory 320 may be reduced.

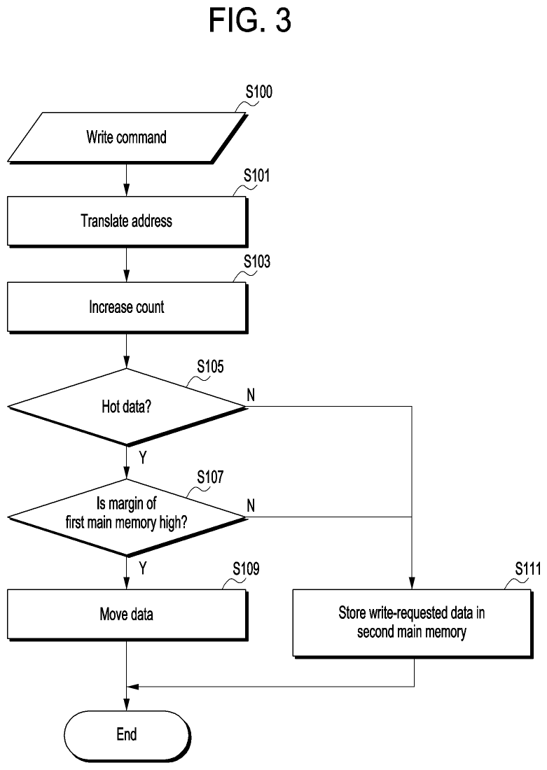

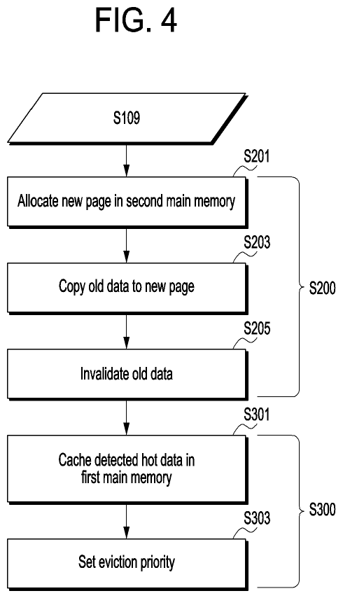

FIGS. 3 and 4 are flow charts illustrating a data management method of a computer system in accordance with an embodiment.

In describing the data management method of FIGS. 3 and 4, it is assumed that, when the computer system 10 receives a request from the host or client device to write data, the memory management system 200 manages write data by mapping a physical address by the unit of an entry. Each entry may include a data value and meta-information (META) including an identifier of the data value.

In response to a write command (S100) of the host device or the client device, the address mapping component 203 translates a logical address of the write-requested data into a physical address which is used in the computer system 10 (S101).

The attribute management component 205 includes the access count table 2051 for managing a write count CNT for each logical address ADD. The attribute management component 205 may increase a write count CNT corresponding to a logical address ADD of the write-requested data (S103).

When the write-requested data is stored in the second main memory 320, the attribute management component 205 may determine whether the data is hot data, based on the write count CNT (S105). For example, when the write count CNT is greater than or equal to the set threshold value TH, the attribute management component 205 may determine that the data is hot data.

When it is determined that the data is hot data (S105:Y), the first memory controller 220 may determine a margin of the first main memory 310 (S107). In an embodiment, the first memory controller 220 may manage the first main memory 310 by dividing it into a plurality of blocks, and may determine a margin of the first main memory 310 based on a cache miss count for the first main memory 310 and the number of the blocks in the first main memory 310. If a cache miss count for the first main memory 310 during a set time is greater than the number of the blocks of the first main memory 310, the first memory controller 220 may determine that a margin of the first main memory 310 is high. Otherwise, the margin of the first main memory 310 is determined to be low.

When it is determined that the margin of the first main memory 310 is high (S107:Y), the second memory controller 230 may select a specific page in the second main memory 320, and may perform a data movement process (S109).

When it is determined that the data is not hot data (S105:N) or when it is determined that the margin of the first main memory 310 is low (S107:N), the write-requested data may be stored in the second main memory 320 (S111).

With reference to FIG. 4, the data movement process S109 is described in detail.

Referring to FIG. 4, the data movement process S109 may include a wear-leveling process S200 and a wear-reduction process S300.

The wear-leveling process S200 is as follows.

The second memory controller 230 may manage a plurality of pages which configure the second main memory 320, in the LRU queue 231. When hot data is detected, the second memory controller 230 may select a new page, to which the hot data is to be moved, from the LRU queue 231 (S201).

The mover 207 may move the hot data to the new page selected by the second memory controller 230 (S203). From this, the fact that hot data is detected indicates that a region in which the hot data is stored is a hot page with a high access frequency, and data of the hot page may be old data. Thereafter, the old data of the hot page in which the hot data was stored is invalidated (S205).

In summary, if hot data is detected among data stored in the second main memory 320, the detected hot data may be moved to another page in the second main memory 320 to uniformly manage the wear of the second main memory 320.

The wear-reduction process S300 is as follows.

The mover 207 may store the detected hot data in the first main memory 310 (S301). Then that hot data whose page has been replaced in the second main memory 320 may be tagged hot data, which sets an eviction priority for data in the first main memory 310 (S303). In an embodiment, the tag indicates that the associated data, which is hot, is not to be evicted from the first main memory 310. The hot data tag may be managed through the access count table 2051.

If the first main memory 310 is full, a data eviction operation of evicting data from the first main memory 310 and moving such data to the second main memory 320 is performed. Because data tagged as hot data is prevented from being evicted from the first main memory 310 to the second main memory 320, quick access to hot data may be provided, and at the same time, access count to the second main memory 320 may be minimized.

In this way, by moving hot data within the second main memory 320, e.g., from one page to another page, the wear of the second main memory 320 may be uniformly managed (wear-leveling), and, by allowing detected hot data to be accessed in the first main memory 310, the wear of the second main memory 320 may be reduced (wear-reduction).

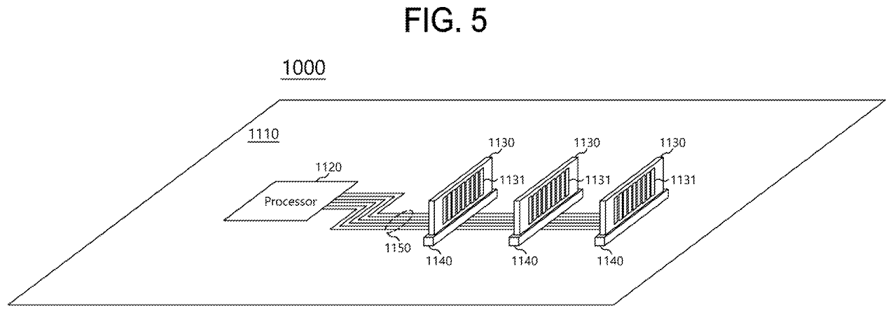

FIG. 5 is a diagram illustrating an example of the configuration of a system 1000 in accordance with an embodiment. In FIG. 5, the system 1000 may include a main board 1110, a processor 1120 and memory modules 1130. The main board 1110, on which components constituting the system 1000 may be mounted, may be referred to as a mother board. The main board 1110 may include a slot (not illustrated) in which the processor 1120 may be mounted and slots 1140 in which the memory modules 1130 may be mounted. The main board 1110 may include wiring lines 1150 for electrically coupling the processor 1120 and the memory modules 1130. The processor 1120 may be mounted on the main board 1110. The processor 1120 may include a central processing unit (CPU), a graphic processing unit (GPU), a multimedia processor (MMP) or a digital signal processor. Further, the processor 1120 may be realized in the form of a system-on-chip by combining processor chips having various functions, such as application processors (AP).

The memory modules 1130 may be mounted on the main board 1110 through the slots 1140 of the main board 1110. The memory modules 1130 may be coupled with the wiring lines 1150 of the main board 1110 through module pins formed in module substrates and the slots 1140. Each of the memory modules 1130 may include, for example, an unbuffered dual in-line memory module (UDIMM), a dual in-line memory module (DIMM), a registered dual in-line memory module (RDIMM), a load-reduced dual in-line memory module (LRDIMM), a small outline dual in-line memory module (SODIMM) or a nonvolatile dual in-line memory module (NVDIMM).

The memory management system 200 may be mounted in the processor 1120 in a form of hardware or a combination of hardware and software. The main memory device 200 in FIG. 1 may be applied as the memory module 1130. Each of the memory modules 1130 may include a plurality of memory devices 1131. Each of the plurality of memory devices 1131 may include at least one of a volatile memory device and a nonvolatile memory device. The volatile memory device may include an SRAM, a DRAM or an SDRAM, and the nonvolatile memory device may include a ROM, a PROM, an EEPROM, an EPROM, a flash memory, a PRAM, an MRAM, an RRAM or an FRAM. The second memory device 320 of the main memory device 300 in FIG. 1 may be applied as the memory device 1131 including a nonvolatile memory device. Moreover, each of the memory devices 1131 may include a stacked memory device or a multi-chip package which is formed as a plurality of chips are stacked.

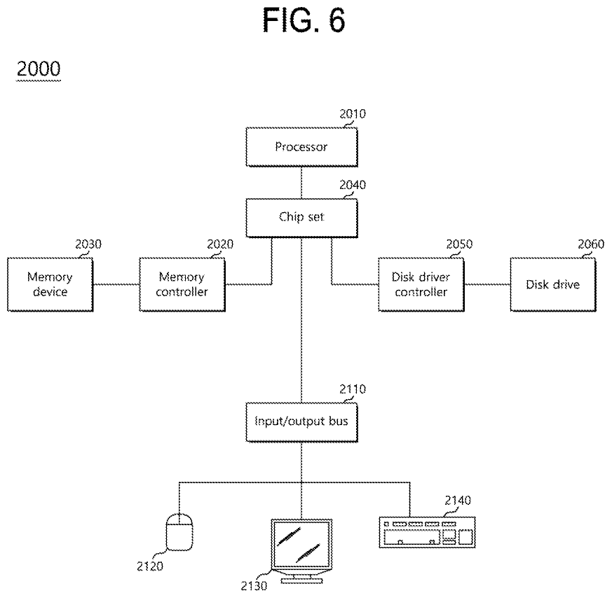

FIG. 6 is a diagram illustrating an example of the configuration of a system 2000 in accordance with an embodiment. In FIG. 6, the system 2000 may include a processor 2010, a memory controller 2020 and a memory device 2030. The processor 2010 may be coupled with the memory controller 2020 through a chip set 2040, and the memory controller 2020 may be coupled with the memory device 2030 through a plurality of buses. While one processor 2010 is illustrated in FIG. 6, it is to be noted that the present invention is not specifically limited to such configuration; a plurality of processors may be provided physically or logically.

The chip set 2040 may provide communication paths between the processor 2010 and the memory controller 2020. The processor 2010 may perform an arithmetic operation, and may transmit a request and data to the memory controller 2020 through the chip set 2040 to input/output desired data.

The memory controller 2020 may transmit a command signal, an address signal, a clock signal and data to the memory device 2030 through the plurality of buses. By receiving the signals from the memory controller 2020, the memory device 2030 may store data and output stored data to the memory controller 2020. The memory device 2030 may include at least one memory module. The main memory device 200 of FIG. 1 may be applied as the memory device 2030.

In FIG. 6, the system 2000 may further include an input/output bus 2110, input/output devices 2120, 2130 and 2140, a disk driver controller 2050 and a disk drive 2060. The chip set 2040 may be coupled with the input/output bus 2110. The input/output bus 2110 may provide communication paths for transmission of signals from the chip set 2040 to the input/output devices 2120, 2130 and 2140. The input/output devices may include a mouse 2120, a video display 2130 and a keyboard 2140. The input/output bus 2110 may include any communication protocol communicating with the input/output devices 2120, 2130 and 2140. Further, the input/output bus 2110 may be integrated into the chip set 2040.

The disk driver controller 2050 may operate by being coupled with the chip set 2040. The disk driver controller 2050 may provide communication paths between the chip set 2040 and the at least one disk drive 2060. The disk drive 2060 may be utilized as an external data storage device by storing commands and data. The disk driver controller 2050 and the disk drive 2060 may communicate with each other or with the chip set 2040 by using any communication protocol including the input/output bus 2110.

While various embodiments have been described above, it will be understood to those skilled in the art that the embodiments described are examples only. Accordingly, the present invention is not limited by or to any of the described embodiments. The present invention encompasses all modifications and variations to any of the disclosed embodiments that fall within the scope of the claims.

What is claimed is:

1. A computer system comprising:
a first main memory;
a second main memory having an access latency different from that of the first main memory; and
a memory management system configured to manage the second main memory by dividing it into a plurality of pages, detect a hot page, among the plurality of pages, based on a write count of data stored in the second main memory, and move data of the hot page to a new page in the second main memory and to the first main memory.

2. The computer system according to claim 1, wherein the memory management system is configured to, in response to a write command including a logical address and data received from an external device, generate and update an access count table which stores a write count for the logical address.

3. The computer system according to claim 1, wherein the memory management system manages, by a tag, a priority with which data stored in the first main memory is evicted from the first main memory, and an eviction priority of the data of the hot page is set to be lower than priorities of other data.

4. The computer system according to claim 1, wherein the memory management system manages a least recently used (LRU) queue which is configured to store addresses of the plurality of pages in the second main memory in a particular access order, and selects the new page from the LRU queue.

5. The computer system according to claim 1, further comprising:
a central processing unit configured to transmit data to, and receive data from, the first and second main memories, the first main memory being a cache memory of the central processing unit.

6. The computer system according to claim 1, wherein the first main memory is a write buffer of the second main memory.

7. The computer system according to claim 1, wherein the memory management system manages the data as a pair of meta-information and a data value.

8. The computer system according to claim 1, wherein the memory management system moves the data of the hot page to the first main memory when data previously stored in the first main memory is not accessed for a set time.

9. A data management method of a computer system including a first main memory and a second main memory which has an access latency different from that of the first main memory, the data management method comprising:
detecting, by a memory management system, a hot page based on a write count of data stored in the second main memory, the memory management system managing the second main memory by dividing it into a plurality of pages; and
moving, by the memory management system, data of the hot page to a new page in the second main memory and to the first main memory.

10. The data management method according to claim 9, further comprising:
receiving, by the memory management system, a write command including a logical address and data from an external device;
counting a write count for the logical address; and
detecting the hot page among the plurality of pages based on a result of the counting.

11. The data management method according to claim 9, further comprising:
setting, by the memory management system, an eviction priority of the data of the hot page moved to the first main memory to be lower than priorities of other data.

12. The data management method according to claim 9, further comprising:
managing, by the memory management system, addresses of the plurality of pages in the second main memory, in a least recently used (LRU) queue in a particular access order; and
selecting the new page from the LRU queue.

13. The data management method according to claim 9, wherein the memory management system manages the data as a pair of meta-information and a data value.

14. The data management method according to claim 9, wherein the moving of the data of the hot page to the first main memory comprises moving the data of the hot page to the first main memory when data previously stored in the first main memory is not accessed for a set time.

15. A computer system comprising:
a central processing unit;
a main memory device including a first main memory and a second main memory which are heterogeneous memories, the second main memory including a plurality of pages; and
a memory management system coupled between the central processing unit and a main memory device, including a first memory controller configured to control the first main memory and a second memory controller configured to control the second main memory, the memory management system being configured to control the first and second memory controllers to:
receive data from the central processing unit in response to a write command;
determine whether the received data is hot data;
when it is determined that the received data is hot data, determine a margin of the first main memory; and
when it is determined that the received data is hot data and that the margin of the first main memory is greater than a threshold margin, move the hot data from its current location in the second main memory to another location in the second main memory, and store the hot data in the first main memory with a tag indicating that it is not to be evicted from the first main memory.

16. The computer system according to claim 15, wherein when it is determined that the received data is not hot data or when it is determined that the margin of the first main memory is less than or equal to the threshold margin, the received data is stored in the second main memory.

17. The computer system according to claim 15, wherein the memory management system is configured to detect the hot data based on a write count of data stored in the second main memory.

18. The computer system according to claim 15, wherein the memory management system is configured to determine the margin of the first main memory according to whether data previously stored in the first main memory is accessed for a set time.

19. The computer system according to claim 15, wherein the memory management system manages a least recently used (LRU) queue which is configured to store addresses of the plurality of pages in the second main memory in a particular access order, and selects the another location e from the LRU queue.
